(19) United States
(12) Patent Application Publication
(10) Pub. No.: US 2017/0047753 A1
(43) Pub. Date: Feb. 16, 2017

(54) BATTERY CHARGER FOR A MOBILE ELECTRONIC DEVICE

(71) Applicant: ASIAN EXPRESS HOLDINGS LIMITED, Mongkok, Kowloon (HK)

(72) Inventor: Harry David Precheur, Naples, FL (US)

(21) Appl. No.: 15/308,499

(22) PCT Filed: May 6, 2015
(86) PCT No.: PCT/US2015/029541

§ 371 Date: Nov. 2, 2016

Related U.S. Application Data
(60) Provisional application No. 61/989,093, filed on May 6, 2014.

(51) Int. Cl. H02J 7/00

(52) U.S. Cl. CPC H02J 7/0044; H02J 7/007

(57) ABSTRACT

A battery charging system for a communication device comprises a housing; a charging circuit positioned within the housing; an electrical prong pivotally coupled to the housing, wherein the electrical prong comprises a protrusion positioned at a base of the prong, the protrusion sized to produce an interference fit with the electrical outlet; and an electrical connector at least partially protruding from a bottom surface of the housing, the electrical connector configured to engage a mating electrical jack of the communication device to enable charging of the communication device.

### CROSS-REFERENCE TO RELATED APPLICATIONS

This application claims the benefit of U.S. Provisional Application No. 61/989,093, filed May 6, 2014, and titled BATTERY CHARGER FOR A MOBILE ELECTRONIC DEVICE, which is hereby incorporated herein by reference in its entirety.

### BACKGROUND

Field

The present disclosure relates generally to a battery charger or power adapter for communication or mobile electronic devices (e.g., mobile telephones, mobile texting devices, electronic pad devices, tablets, laptop computers, desktop computers, gaming devices, and/or devices capable of linking electronically to another device or to a network such as the Internet, etc.)

Description of the Related Art

In recent years, many advances in wireless technology, software, and hardware along with a reduction in prices have increased the popularity, usage, and ownership of mobile phones and other mobile electronic devices. In many cases, these types of devices have become an integral part of everyday life for many people. However, portable use of such devices is limited by the amount of power that can be supplied by a battery. Therefore, a battery charger or power adapter may be required to recharge the battery when the power level is low for further use. Design constraints for such chargers or power adapters include weight, size, expense, shape, portability, and/or aesthetics. Consequently, there remains a need for an improved battery charger or power adapter.

### SUMMARY

An aspect of at least one of the embodiments disclosed herein includes providing a battery charging system for a communication or mobile electronic device that includes a housing; a charging circuit positioned within the housing, the charging circuit comprising electrical components configured to convert an electrical input into a regulated output suitable for use in charging the communication device; an electrical prong pivotally coupled to the housing, the electrical prong having a closed position and an open position, wherein, in the closed position, the electrical prong is positioned substantially within a cavity of the housing, and, in the open position, the electrical prong extends from the back surface of the housing in a configuration enabling the electrical prong to be inserted into an electrical outlet to close an electrical connection between the charging circuit and the electrical outlet, wherein the electrical prong comprises a protrusion positioned at a base of the prong, the protrusion sized to produce an interference fit with the electrical outlet; and an electrical connector at least partially protruding from a bottom surface of the housing, the electrical connector configured to engage a mating electrical jack of the communication device to enable the regulated output to charge the communication device.

Another aspect of at least one of the embodiments disclosed herein includes providing a battery charging system for a communication or mobile electronic device that includes a housing comprising an electrically conductive material; a charging circuit positioned within the housing, the charging circuit comprising electrical components configured to convert an electrical input into a regulated output suitable for use in charging the communication device; an electrical prong sized to be inserted into an electrical outlet to close an electrical connection between the charging circuit and the electrical outlet; an electrical connector at least partially protruding from a bottom surface of the housing, the electrical connector configured to engage a mating electrical jack of the communication device to enable the regulated output to charge the communication device; and a first insulating layer comprising a material having electrical insulating properties, the insulating layer positioned at least partially between the housing and the charging circuit.

Another aspect of at least one of the embodiments disclosed herein includes providing a battery charging system for a communication or mobile electronic device that includes a housing; a charging circuit positioned within the housing, the charging circuit comprising electrical components configured to convert an electrical input into a regulated output suitable for use in charging the communication device; an electrical prong pivotally coupled to the housing, the electrical prong having a closed position and an open position, wherein, in the closed position, the electrical prong is positioned substantially within a cavity of the housing, and, in the open position, the electrical prong extends from the back surface of the housing in a configuration enabling the electrical prong to be inserted into an electrical outlet to close an electrical connection between the charging circuit and the electrical outlet; an electrical connector at least partially protruding from a bottom surface of the housing, the electrical connector configured to engage a mating electrical jack of the communication device to enable the regulated output to charge the communication device; and a locking protrusion configured to engage the communication device to at least partially support a weight of the communication device while the electrical connector is engaged with the electrical jack of the communication device.

Another aspect of at least one of the embodiments disclosed herein includes the realization that battery charging systems that are relatively thin and/or have small dimensions, layout, or footprint can provide improved aesthetics, convenience, and portability for a user.

### BRIEF DESCRIPTION OF THE DRAWINGS

These and other features and advantages of the present embodiments will become more apparent upon reading the following detailed description and with reference to the accompanying drawings of the embodiments, in which:

FIG. 1 is a rear view of a battery charger in accordance with an embodiment described herein;

FIG. 2 is an exploded perspective view of the battery charger of FIG. 1;

FIG. 3 is a rear perspective view of the battery charger of FIG. 1 with the one or more prongs in a first position;

FIG. 4 is a rear perspective view of the battery charger of FIG. 1 with the one or more prongs in a second position;

FIG. 5 is a front perspective view of the battery charger of FIG. 1 illustrating certain features in accordance with an embodiment described herein;

FIG. 6 is a front perspective view of the battery charger of FIG. 1 illustrating certain features in accordance with an embodiment described herein;

FIGS. 7A-7B are a side view and a front view of the battery charger of FIG. 1;

FIGS. 8A-8B are front perspective views of the battery charger of FIG. 1 illustrating certain features in accordance with embodiments described herein; and

FIGS. 9A-9B illustrate the battery charger of FIG. 1 connected to a mobile phone for plugging into a wall socket in accordance with certain embodiments described herein.

FIGS. 10A-10L illustrate another embodiment of a battery charger.

### DETAILED DESCRIPTION

An improved battery charging system or assembly (e.g., battery charger, power adapter, power supply) for a communication or mobile electronic device is disclosed herein. The battery charger is configured to charge a mobile phone battery and/or provide a power source or electrical communication with a power source for a charging system (e.g., charging circuit, printed circuit) contained within a mobile phone and/or battery for charging the battery. The embodiments disclosed herein are described in the context of a wall plug-in battery charger for a mobile phone battery because the embodiments disclosed herein have particular utility in this context. However, the embodiments and inventions herein can also be applied to other power sources (e.g., solar powered, battery powered, thermoelectric device powered) and/or other communication or mobile electronic devices.

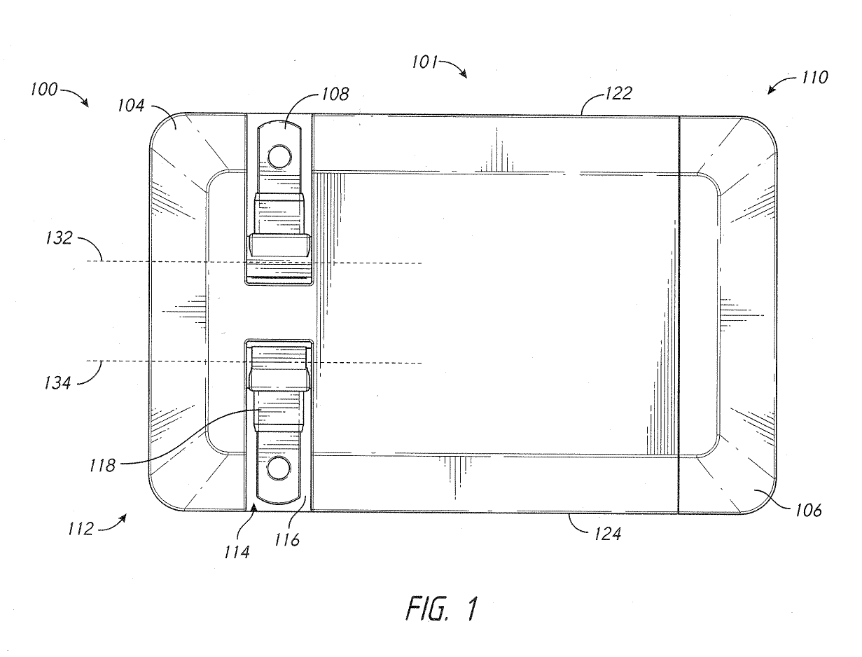

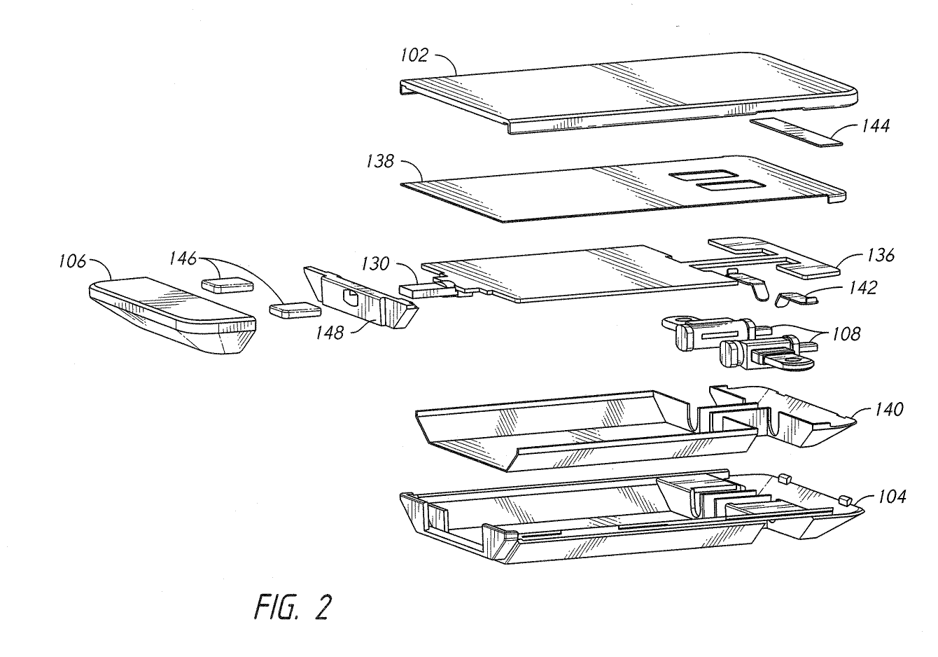

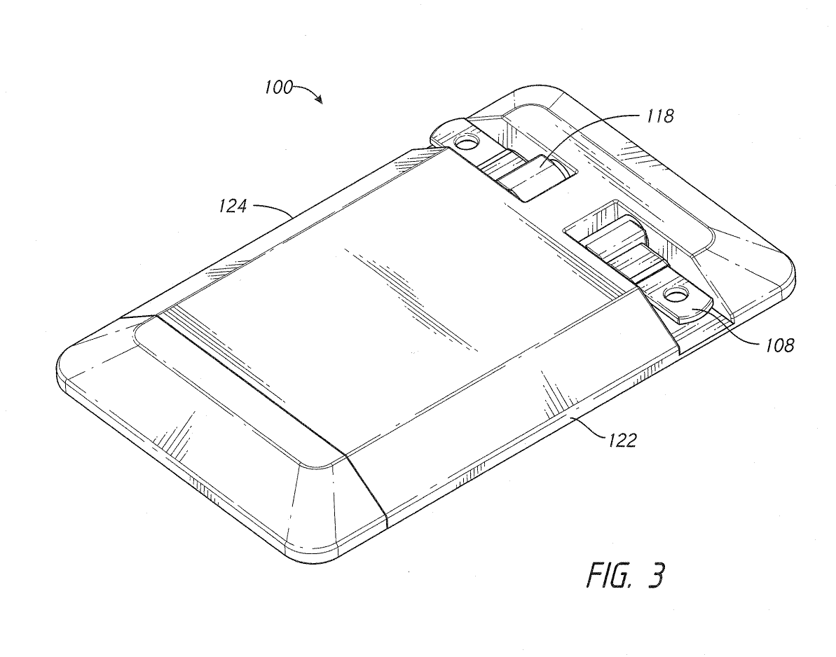

With reference to FIGS. 1-9, an embodiment of a battery charger 100 (e.g., power adapter, power supply, charger) is illustrated. The battery charger 100 can include an exterior or outer protective case or housing assembly 101 (e.g., shell, cover, housing). As illustrated in FIGS. 1-2, the housing assembly 101 can include multiple components including an upper cover 102 (e.g., on a front side), a lower cover 104 (e.g., on a back side), and a removable end cap 106 (e.g., jack, plug, or connector cover). As shown in FIG. 1, the removable end cap 106 can be connected or coupled with a first end 110 (e.g., bottom end or first side) of the housing 101 to protect or cover certain electrical components (e.g., electrical connectors, wires, jacks 130) of the battery charger 100 configured to connect to a communication device (e.g., mobile phone 120) that extend away from and/or out of the housing assembly 101 (e.g., first end 110) from exposure when not in use and/or to provide an aesthetically pleasing, stream-lined, clean or uniform appearance, and/or generally symmetrical appearing housing assembly 101. The end cap 106 can be a hinge-less cap as illustrated. However, in some embodiments, the end cap 106 is hingedly attached to the housing assembly 101.

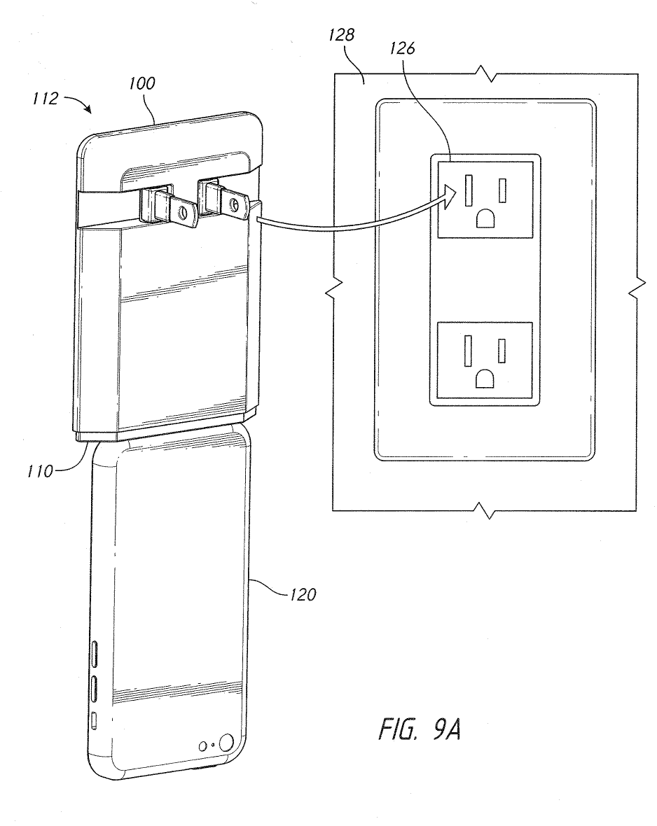

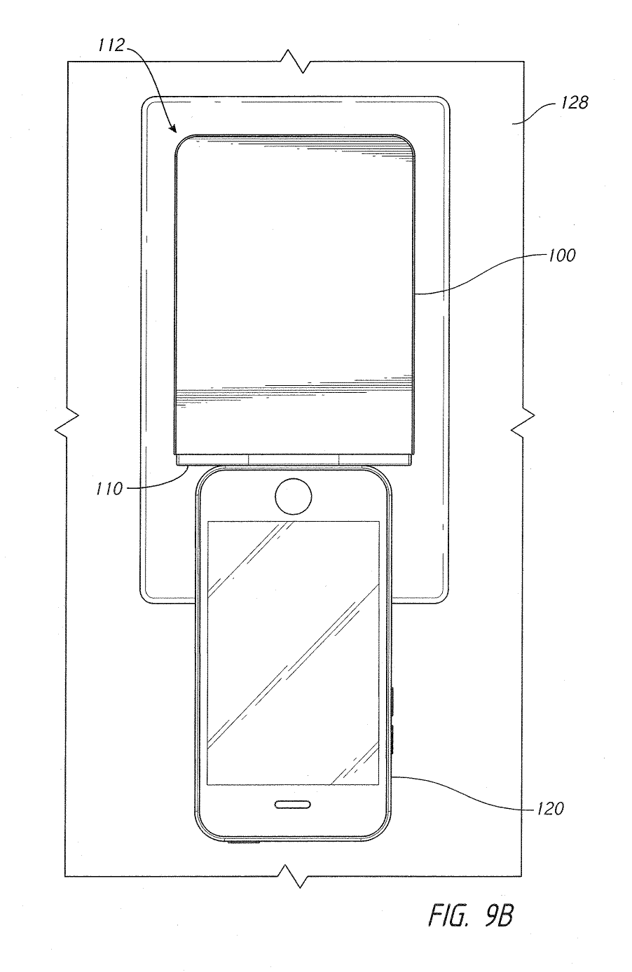

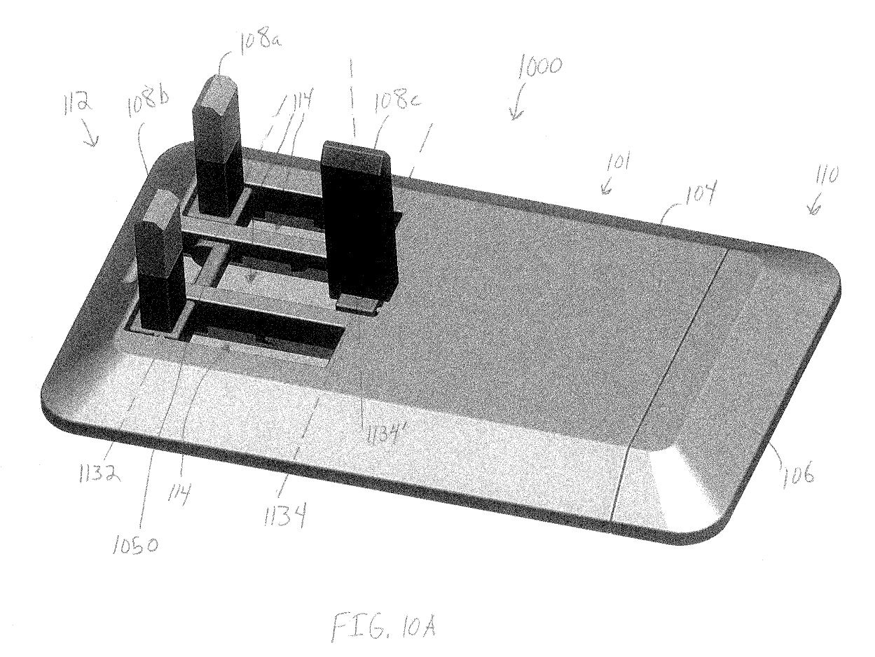

In some embodiments, the battery charger 100 is configured to either charge a mobile phone battery or provide a power source or electrical communication with a power source for a charging system (e.g., circuitry) contained within a mobile phone and/or battery for charging the mobile phone battery. For example, as illustrated in FIGS. 9A-9B, the battery charger 100 can be configured to be plugged (e.g., connected, coupled, mounted, in electrical communication with) into an electrical socket, receptacle or outlet 126 (e.g., of a home, office, wall, adapter, power strip, extension cord, converter, etc.) and be connected (e.g., in electrical communication) to a mobile phone 120 as discussed below to charge the battery of the mobile phone 120. As illustrated in FIG. 2, in some embodiments, the charger 100 does not include a rechargeable battery or other power supply as the charger 100 is adapted to be a plug-in type charger and provide power to the mobile phone 120 via the outlet 126 and is not configured to charge the mobile phone 120 when unplugged from the outlet 126. However, in other embodiments, the charger 100 can include a rechargeable battery or other power supply to charge the mobile phone 120 when unplugged from the outlet 126.

As illustrated in the exploded view of the battery charger 100 of FIG. 2, in certain embodiments, the housing assembly 101 can be configured to house a printed circuit 136 (e.g., board, assembly) surrounded, sandwiched between and/or insulated by an upper or top insulation cover 138 and a lower or bottom insulation cover 140. The insulation covers 138, 140 can be constructed of plastic (e.g., mylar) or any other suitably insulating material. The insulation covers 138, 140 can be shaped to fit within corresponding shaped-recesses of the upper and lower covers 102, 104. As illustrated in FIG. 2, in some embodiments, the recess of the upper cover 102 and upper insulation cover 138 both have a generally planar or sheet-like configuration. In some embodiments, the recess of the lower cover 104 and lower insulation cover 140 both have a generally trapezoidal configuration. Both the covers and insulation covers can have various shaped configurations including generally planar, sheet-like, trapezoidal, U-shaped, V-shaped, rectangular or other angular configuration.

In some embodiments, the insulation covers 138, 140 are necessary or required (e.g., as a safety precaution) in order to insulate the printed circuit 136 and/or prevent electrical power (e.g., current, voltage) flowing from the outlet 126 through the charger 100 (e.g., to the mobile phone 120) from passing through the upper and lower covers 102, 104 that are made of metal and/or another electrically conductive material. The insulating covers 138, 140 can decrease or eliminate the potential for electrical shocks or surges. In various embodiments, some, substantially all, or the entire battery charger 100 is made of one or more generally corrosion-resistant materials and/or electrically conductive materials. For example, upper cover 102, end cap 106 and/or lower cover 104 can be aluminum (e.g., extruded aluminum, formed satin aluminum that is bead blasted with clear anodizing, etc.). In some embodiments, the battery charger 100 does not include such insulating covers. The covers 102, 104 and/or end cap 106 may be constructed of other suitable materials, including, but not limited to, steel, stainless steel, titanium, copper or any other metal, plastic, wood, or any other material.

As further illustrated in FIG. 2, in certain implementations, the upper and lower covers 102, 104, insulation covers 138, 140, and/or printed circuit 136 are configured with one or more generally aligned cut-out portions (e.g., recesses, apertures, channels) configured to receive one or more prongs 108 and/or allow the one or more prongs 108 to rotate. The one or more prongs 108 are configured to be inserted into the socket 126 to connect the charger 100 to the outlet 126 to provide electrical communication between (or power to) the mobile phone 120 (e.g., battery, charging circuit) and/or a power source in electrical communication with the outlet 126 in order to charge the battery. The one or more prongs 108 can be connected (e.g., in electrical communication) with the printed circuit 136 via one or more copper (or other conductive material) members 142 (e.g., contacts).

In some embodiments, the printed circuit or circuit board 136 can comprise a charging circuit comprising electrical components configured to convert AC voltage received from, for example, a household electrical outlet, into regulated DC voltage for charging of, for example, a mobile communication device. In some embodiments, the system can be configured to convert 120 VAC or 240 VAC to a regulated 5 VDC output. In other embodiments, the system can be configured to convert different input voltages to different output voltages based on an application's requirements. In some embodiments, the output can be configured to be user selectable. For example, the system can be configured to enable a user to set the output of the charger to be 3 V, 5 V, or any other voltage as required by the user. In some embodiments, the system can be configured to automatically adjust an output voltage and/or current based on the requirements of a device connected to the system. For example, the system can be configured to electrically determine, upon connection of a mobile device to the charging system, the requirements of that device and to automatically adjust a voltage and/or current output to match that device's requirements.

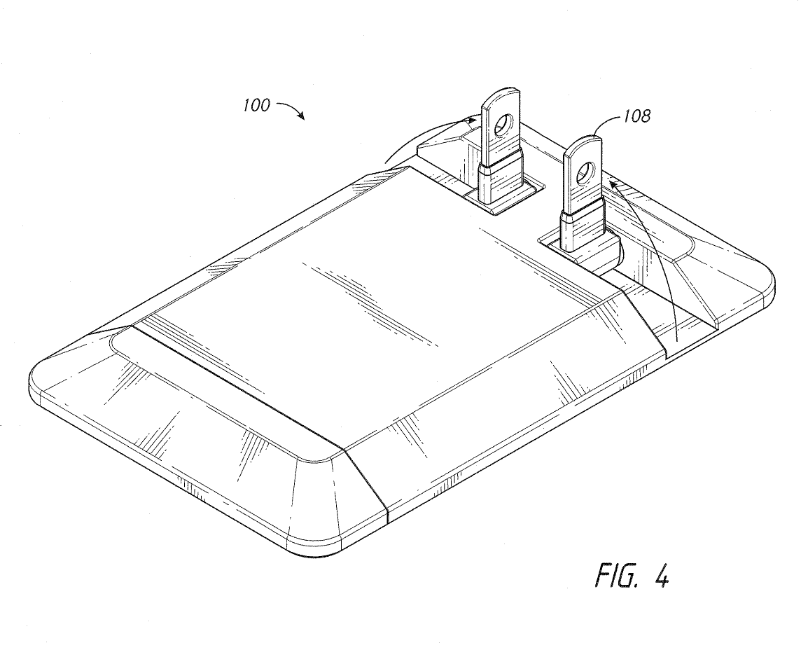

As illustrated in FIGS. 3-4, the one or more prongs 108 can be configured to be foldable (e.g., pivotable, rotatable, retractable) between a closed position when not in use or an open position to be plugged into the socket. In some embodiments, the one or more prongs 108 are positioned generally closer, more adjacent to or more proximal to the second end 112 (e.g., top end or second side) of the housing 101 relative to the first end 110 (e.g., bottom). However, in other embodiments, the one or more prongs 108 can be positioned more proximal to the first end 110, a side of the housing 101, and/or generally in the middle between the first and second ends 110, 112.

The one or more prongs 108 can move or be configured to move (e.g., fold, pivot, rotate, refract) between first and second positions. In the first, engagement, extended, or open position, as illustrated in FIG. 4, the one or more prongs 108 can be configured to extend generally transversely to a longitudinal axis (e.g., extending from the first end 110 to the second end 112) of the housing assembly 101 to be inserted into an electrical socket or outlet. In the second, folded, compact, or closed position, as illustrated in FIG. 3, the one or more prongs 108 are generally positioned within respective recesses 114 formed in at least one of the upper and lower covers 102, 104.

In some embodiments, the one or more prongs 108 can be rotated between the open or first and closed or second positions about axes (as indicated by dashed lines 132, 134) extending generally parallel to the longitudinal axis of the housing assembly 101. In other embodiments, the axes can extend generally transverse or orthogonal to the longitudinal axis of the housing assembly 101. In some embodiments, the prongs 108 are configured to rotate about the same axis. In some embodiments, as shown in FIG. 1, the axes, in addition to being parallel to the longitudinal axis of the housing assembly 101, are also parallel to a transverse axis of the prong 108 (e.g., extending from a side closest the first end 110 to a side closest the second end 112). In some embodiments, the axes are parallel to a longitudinal axis of an opening of an electrical outlet, such as the electrical outlet 126 shown in FIG. 9A. For example, the longitudinal axis of the openings in FIG. 9A is positioned along the wider portion of the openings (e.g., from top to bottom).

In moving between the first and second positions, in certain embodiments, the one or more prongs 108 are rotated approximately 90 degrees about the axes 132, 134. However, in other embodiments, the one or more prongs 108 are rotated about the axes 132, 134 by other amounts, such as at least about: 10 degrees, 20 degrees, 30 degrees, 40 degrees, 50 degrees, 60 degrees, 70 degrees, 80 degrees, 90 degrees, 100 degrees, 110 degrees, 120 degrees, 130 degrees, 140 degrees, 150 degrees, values therebetween or otherwise, in moving between the open and closed positions. In the closed position, the one or more prongs 108 are configured to extend towards opposing sides (e.g., third and fourth sides 122, 124) of the housing assembly 101 and/or lie generally flat, flush, or level against and/or parallel to bottom surfaces 116 of the upper or lower cover 102, 104. In the second or closed positions, the prongs 108 can contact the respective bottom surfaces 116 of the recesses 114 such that they extend towards the third and fourth sides 122, 124 of the housing assembly 101. The third and fourth sides 122, 124 can extend generally transversely to the first and second sides of the housing assembly 101 such that they form corners of the housing assembly 101. In the closed position, the one or more prongs 108 are retracted or generally out of the way such that they do not extend or protrude outwardly from the housing assembly 101 thus allowing a more compact or portable configuration for the battery charger 100 when not in use, for storage, and/or for transport by a user.

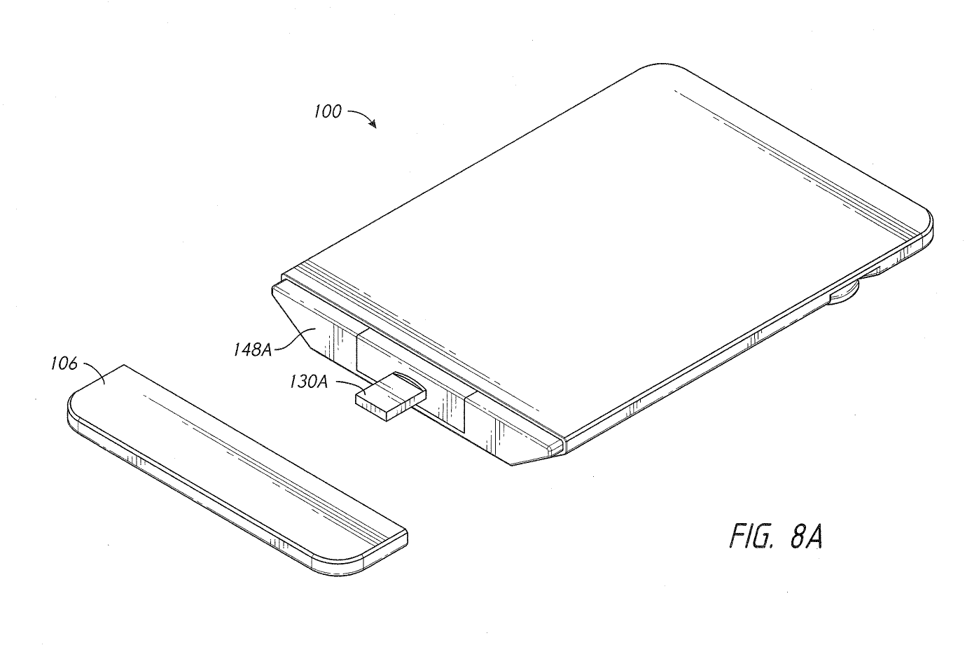

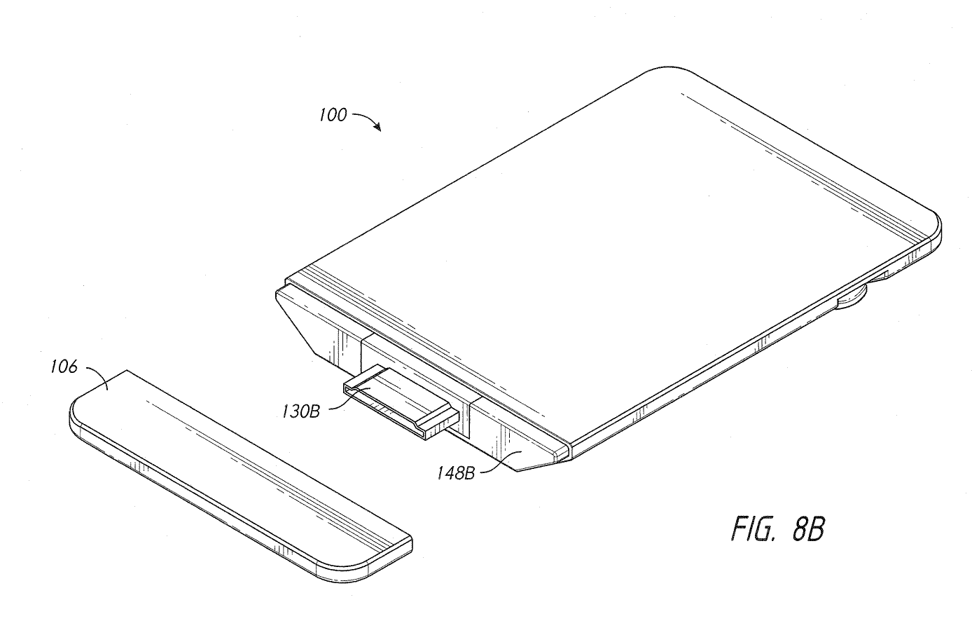

In some embodiments, as illustrated in FIGS. 2 and 8A-8B, the electrical jack 130 in electrical communication with the printed circuit 136 extends through an opening of a front cover 148. The front cover 148 is positioned at and configured to cover the first end 110 (e.g., or the second end 112) of the housing assembly 101. The front cover 148 can be aluminum (e.g., extruded aluminum, formed satin aluminum that is bead blasted with clear anodizing, etc.). In some embodiments, the front cover 148 may be constructed of other suitable materials, including, but not limited to, steel, stainless steel, titanium, copper or any other metal, plastic, wood, or any other material

The electrical plug, connector, or jack 130 in electrical can be a universal serial bus (USB), Micro-USB, “Lightning”, 30-pin, HDMI, or other connector (e.g., male or female) configured to engage or connect with a corresponding connector (e.g., female or male) of the mobile phone 120 (e.g., or other communication device) when the end cap 106 is removed or off. The battery charger 100 can include different shaped openings and/or covers 148 corresponding to different electrical jacks 130. For example, as illustrated in FIG. 8A, in some embodiments, the battery charger 100 can include a Lightning jack 130A configured to extend through an opening of front cover 148A to connect to a mobile phone (e.g., iPhone 5, 5s). As illustrated in FIG. 8B, in other embodiments, the battery charger 100 can include a 30-pin jack 130B configured to extend through a different shaped and/or sized front cover 148B from the cover 148A to connect to a mobile phone (e.g., iPhone 4, 4s). In some embodiments, the battery charger 100 can be configured to directly connect to a mobile device or other device to be charged without using a cable, wire, extension cable, and/or the like. For example, as illustrated in FIGS. 9A and 9B, the battery charger 100 can be configured to directly connect to a mobile phone, in this example with the mobile phone hanging underneath the battery charger, the weight of the mobile phone being supported by the electrical connector 130.

In some embodiments, the electrical jack 130 is configured to be connected or coupled directly or indirectly to the printed circuit 136. The electrical jack 130 can be coupled by an adhesive, soldered, or other engagement member (e.g., screw, pin) to the printed circuit 136. In some embodiments, the electrical jack 130 does not include an extension cable or wire (e.g., wireless). In other embodiments, the electrical jack 130 includes an extension cable or wire. In some embodiments, the extension cable or wire is retractable from an extended position to a retracted position (e.g., retracted within or near the housing assembly 101).

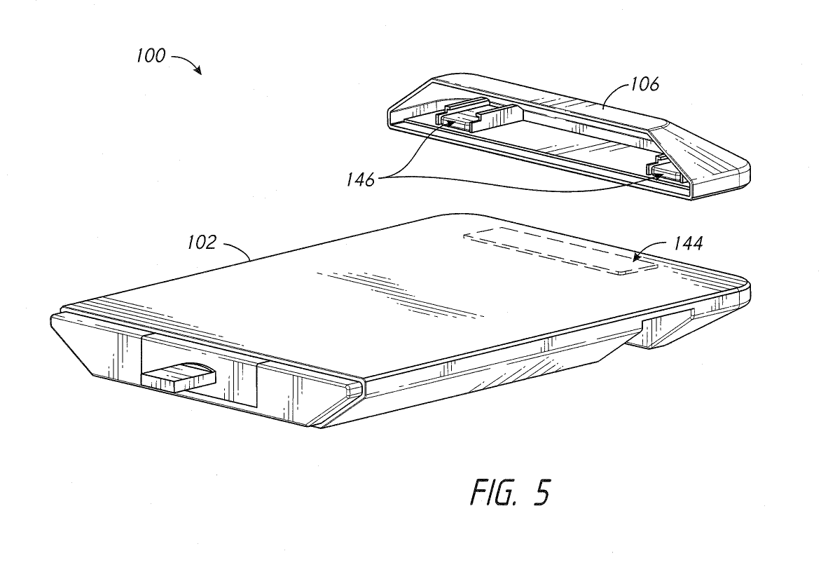

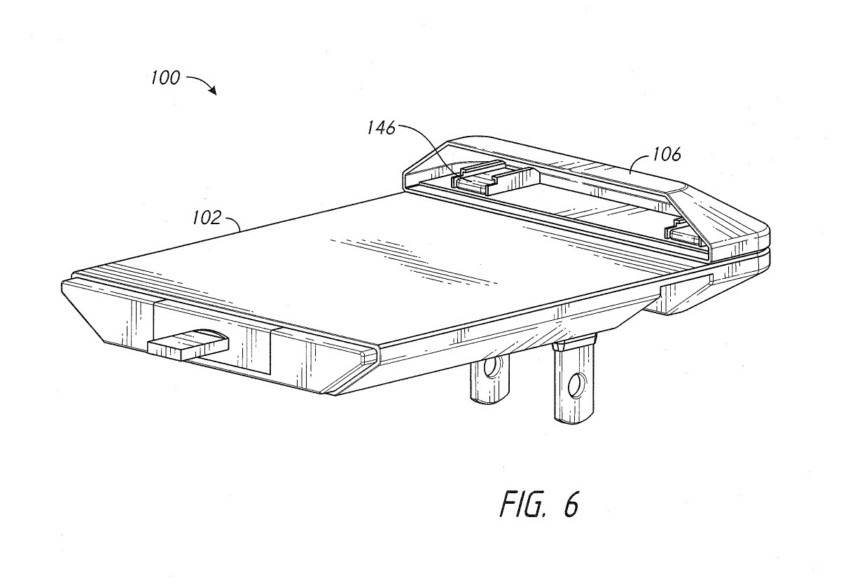

As illustrated in FIGS. 2 and 5-6, in some embodiments, the charger 100 includes one or more magnetic portions (e.g., magnets 146) or ferrous material (e.g., iron plate) positioned within, on, or in an opening, sub-layer, exterior surface, and/or interior surface of the end cap 106. At least one of the upper and lower covers 102, 104 can include one or more corresponding or complementary magnetic areas (e.g., magnets, ferrous material, iron plate 144) on or within an exterior surface, interior surface, and/or sublayer. As illustrated in FIGS. 5-6, in accordance with an embodiment, it is contemplated that the end cap 106 can be magnetically coupled with the magnetic area of at least one of the upper and lower covers 102, 104. The locations of the complementary magnetic area and the magnetic portion can cause the end cap 106 to be drawn onto the housing assembly 101. Thus, the end cap 106 can be retained on the housing assembly 101 upon attraction between the magnetic area and the magnetic portion 80 of the decorative component 20 when the end cap 106 is removed (e.g., for storage).

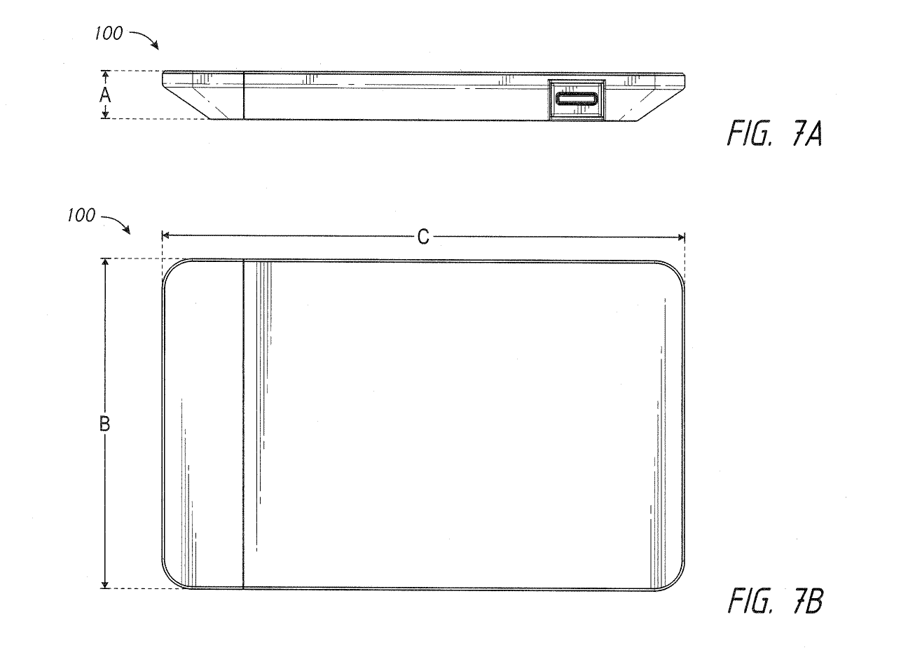

As illustrated in FIGS. 7A-7B, the battery charger 100 can have a thin, compact layout, form-factor, or footprint (e.g., for improved portability, appearance, storage). In some embodiments, the battery charger 100 is sufficiently thin to fit within a wallet or a pocket (e.g., shirt, pants, etc). In some embodiments, third and fourth sides 122, 124 can have a dimension C generally equal to or at least 87.0 mm. However, dimension C in other embodiments can have a value generally equal to or at least 40 mm, 50 mm, 60 mm, 70 mm, 80 mm, 90 mm, 100 mm, 110 mm, 120 mm, values therebetween or otherwise. When assembled, the battery charger can have a maximum thickness (e.g., dimension A) generally equal to or at least 8 mm. However, dimension A in other embodiments can have a value generally equal to or at least 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, values therebetween or otherwise. The first and second ends can have a width (e.g., dimension B) generally equal to or at least 55 mm. However, dimension B in other embodiments can have a value generally equal to or at least 30 mm, 35 mm, 40 mm, 45 mm, 50 mm, 55 mm, 60 mm, 65 mm, 70 mm, 75 mm, 80 mm, values therebetween or otherwise.

As discussed above, FIGS. 1-9 illustrate a battery charger 100 for use with a communication or mobile electronic device. While, the mobile electronic device (e.g., mobile phone 120) illustrated in FIGS. 9A-9B is an iPhone, sold by Apple, Inc. of Cupertino, Calif., the battery charger 100 disclosed herein, may be configured for use with other communication or mobile electronic devices (e.g., including devices by Android, Samsung, LG, HTC, other iPhone models, etc.).

As described above, in certain implementations, the battery charger 100 is configured to be plugged into the wall socket or outlet 126 by the one or more prongs 108 to provide electrical communication between a power source and the mobile phone 120 when the mobile phone 120 is coupled (e.g., in electrical communication, connected via the jack 130) to the charger 100. As illustrated in FIGS. 9A-9B, the socket or outlet 126 can be positioned on a generally vertical extending wall 128 (e.g., in a house, office, etc.). When the mobile phone 120 is connected to the battery charger 100 (e.g., via the jack 130) and/or the battery charger 100 is plugged into the socket or outlet, the weight (e.g., load, stress, force, moment, torque) from the battery charger 100 and/or mobile phone 120 may push or pull the one or more prongs 108 out of the socket (e.g., out of electrical communication) or disengage (e.g., disconnect) the battery charger 100 from the socket.

Therefore, in some embodiments, the one or more prongs 108 can include one or more sleeve (e.g., stabilizing, gripping, protrusion, bumper, gasket resilient, deformable) members 118 positioned at the base of the respective one or more prongs 108 to help secure (e.g., engage, hold, fix in position) the battery charger 100 (and/or the mobile phone 120) to or in the socket or outlet 126. For example, the one or more sleeve members 118 can hold or grip onto a portion of the socket (e.g., by forming a tighter friction or interference fit with receiving apertures of the socket) to generally prevent the battery charger 100 and/or mobile phone 120) from being disconnected or pulled away or out of electrical communication from the power source or outlet 126 due to the weight (e.g., load, stress, force, moment, torque) from the battery charger 100 and/or mobile phone to the outlet 126. Additionally, the one or more sleeve members 118 can reduce or prevent the risk of electrical shock or surge to a user. The one or more sleeve members 118 can be formed of silicone, silicon, rubber, plastic or other suitable materials.

In some embodiments, as illustrated in FIGS. 9A-9B, the mobile phone 120 is configured to be generally inverted (e.g., upside down, extending towards a ground or floor) when connected to the battery charger 100 (e.g., via the jack) and the battery charger 100 is plugged into the wall socket or outlet 126 on the generally vertically extending wall 128. For example, as illustrated in FIGS. 9A-9B, a top surface of the mobile phone 120 is configured to face downwardly when connected to the battery charger 100 that is plugged into the socket 126. However, in other embodiments, the mobile phone 120 is configured to be oriented right-side up such that a top surface of the mobile phone 120 extends or is oriented upwardly towards a ceiling, roof, or sky when connected to the battery charger 100 (e.g., via the jack 130) and the battery charger 100 is plugged into the outlet 126 on the generally vertically extending wall 128. The mobile phone 120 and/or the battery charger 100 can have complementary electrical jacks positioned at various locations (e.g., surfaces or sides) on the mobile phone 120 and/or the battery charger 100 such that a top surface of the mobile phone 120 faces or extends upwardly, downwardly, to a side (e.g., left and/or right), and/or at an oblique angle in various embodiments.

In some embodiments the mobile phone 120 is intended to be positioned in a way such that the weight of the mobile phone 120, or at least a portion of the weight of the mobile phone 120, must be supported by the battery charger 100. For example, when the phone is positioned in a completely inverted orientation, such as is shown in FIGS. 9A and 9B, the entire or most of the weight of the mobile phone 120 must be carried by the battery charger 100. Accordingly, the electrical connector or jack 130 can be configured to engage a mating connector of the mobile phone to not only transfer electrical current, but to also mechanically or physically retain the mobile device. For example, in some embodiments, the electrical connector 130 can be configured to have an interference or friction fit with the mobile phone 120. In some embodiments, this interference or friction fit can be generated through using a resilient member, a spring-loaded member, and/or the like. In some embodiments, the electrical connector 130 can be configured to have one or more locking arms or prongs which are configured to engage one or more openings or depressions of a mating connector of the mobile phone 120. Such prongs can be used in lieu of or in addition to a friction or interference fit to help hold the mobile phone to the charger. In some embodiments, the charger 100 further comprises a button, switch, slider, and/or the like mechanically connected to one or more prongs or locking arms of the electrical connector 130 to enable a user to selectively engage the locking feature of the electrical connector 130. In some embodiments, the battery charger 100 comprises a locking or engaging feature separate from the electrical connector 130. For example, the battery charger 100 may comprise a cavity within which a portion of the mobile phone is configured to be inserted, the cavity comprising an interference, friction, or spring-loaded fit with the portion of the mobile phone. In some embodiments, the battery charger 100 comprises one or more arms or other features configured to engage the mobile phone to help support the weight of the mobile phone.

The housing assembly 101 can have various cross-sectional shapes. For example, the housing assembly 101 can have a cross-sectional shape that is generally: cylindrical, circular, triangular, trapezoidal, rectangular, square, V-shaped, U-shaped, or other angular cross-sectional configuration. In some embodiments, housing assembly 101 has generally rounded or smooth corners or edges. In other embodiments, the housing assembly 101 has generally angled, linear, or sharp corners or edges. As illustrated in FIGS. 1-9, the housing assembly 101 can be trapezoidal in cross-section with a lower cover 104 configured to taper (e.g., incline, slope, angle) in length along the thickness or width of the lower cover (e.g., from a base surface to a top surface such that the top surface is shorter in length relative to the base surface, the base surface extending in a generally parallel direction to the top surface). However, in other embodiments, the housing assembly 101 is generally rectangular in cross-section.

In certain embodiments, the covers 102, 104 include complementary engagement members 122 (e.g., pins, screws, nails, protrusions, tabs) for engagement with a corresponding engagement structure 124 (e.g., hole, opening, channel, aperture, recesses) for retaining components of the housing assembly 101 together (e.g., upper and lower covers 102, 104). As illustrated, in some embodiments, the covers 102, 104 can be slidably engaged or retained with one another. In such configurations, the covers 102, 104 can be configured to be retained together by an interference or friction fit. In some embodiments, the covers 102, 104 are formed without screw or pin through-holes in their respective outer surfaces, thus giving the battery charger 100 a generally improved sleek, smooth, and luxurious appearance.

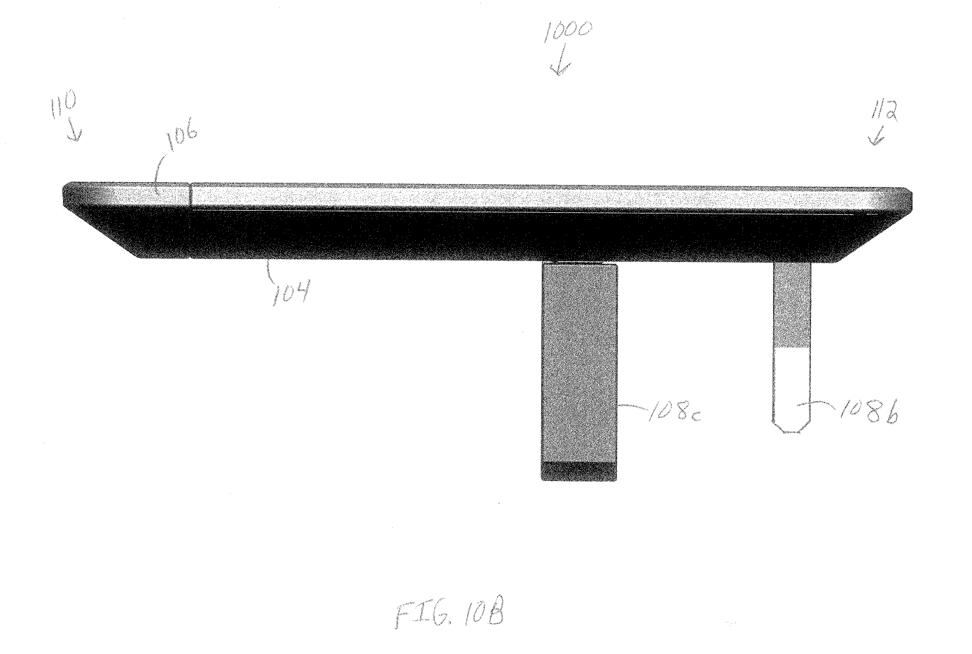

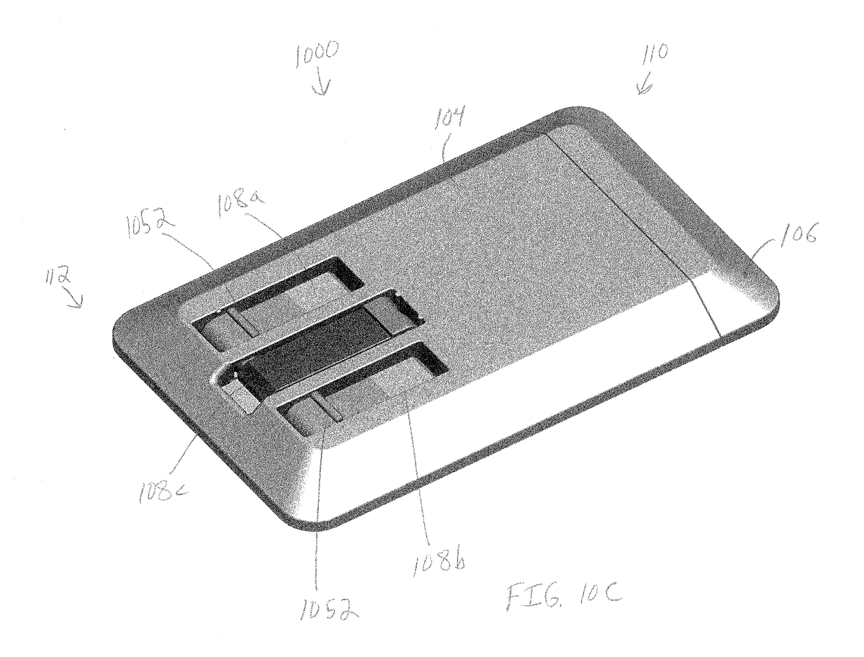

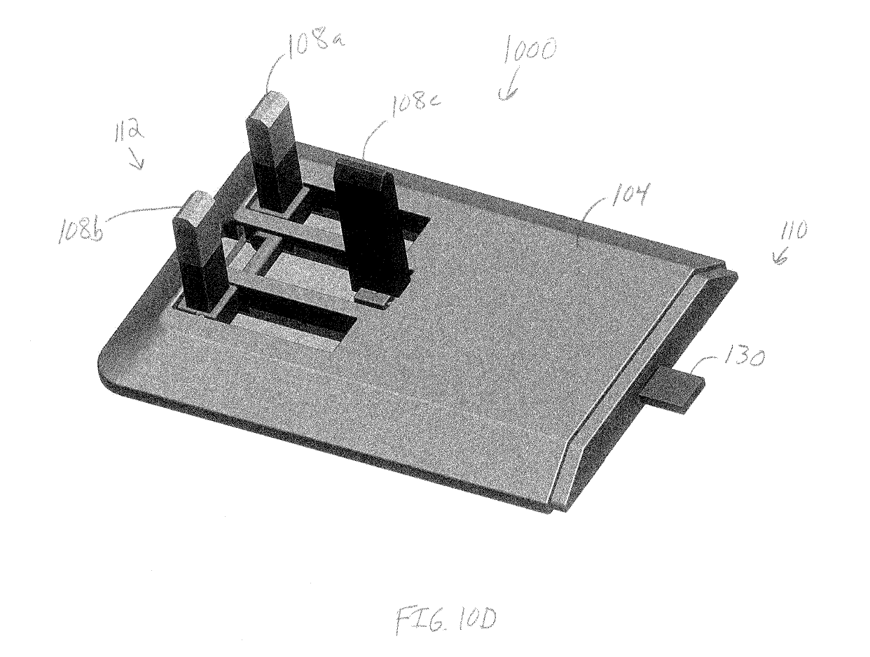

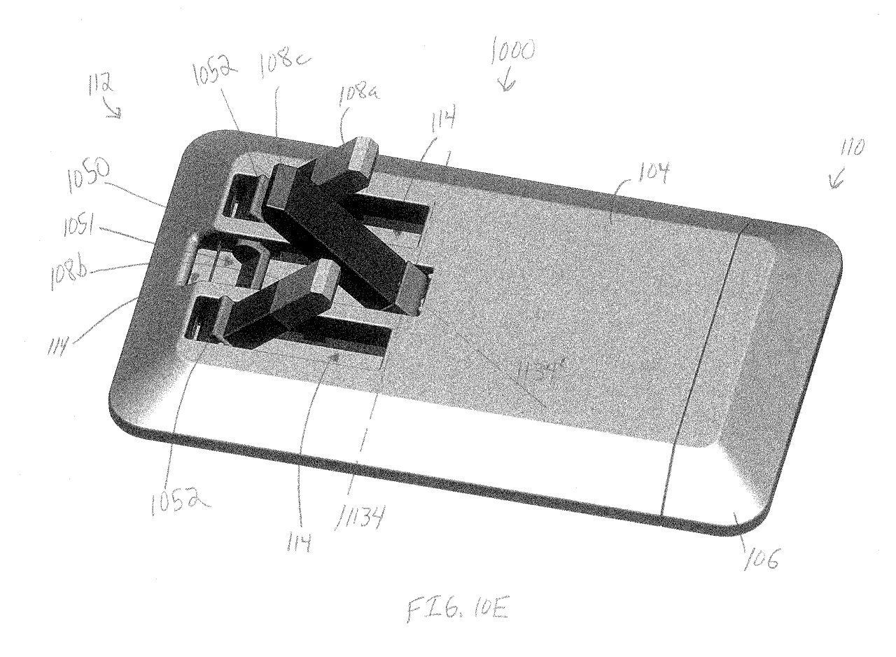

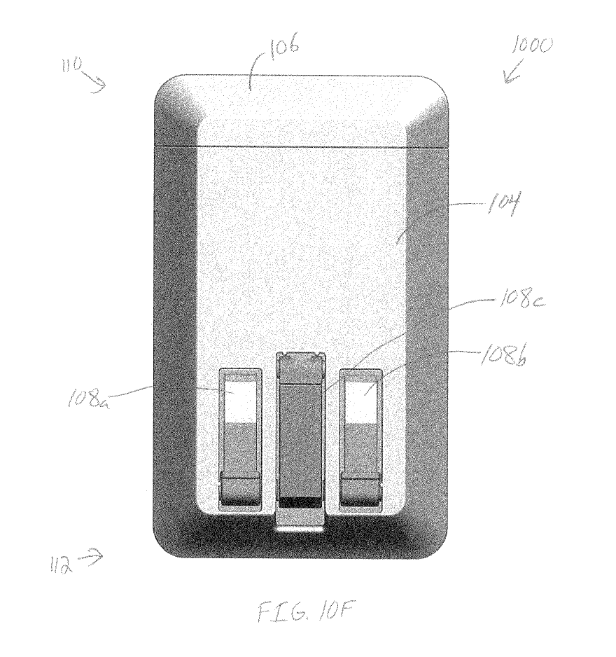

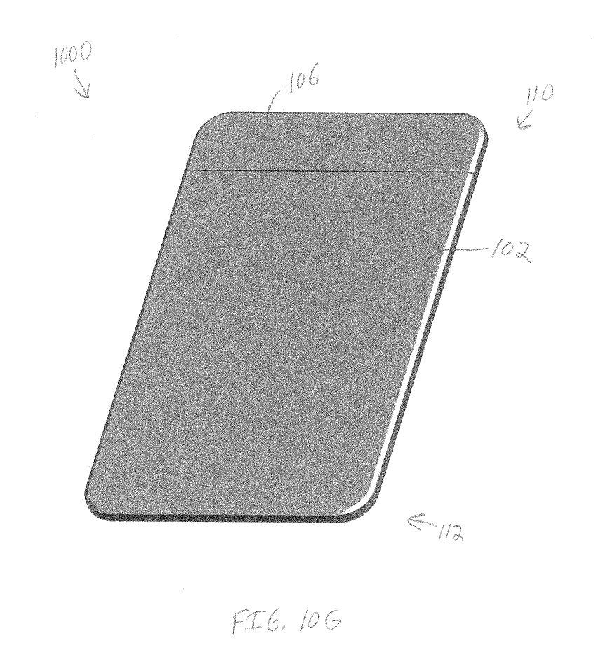

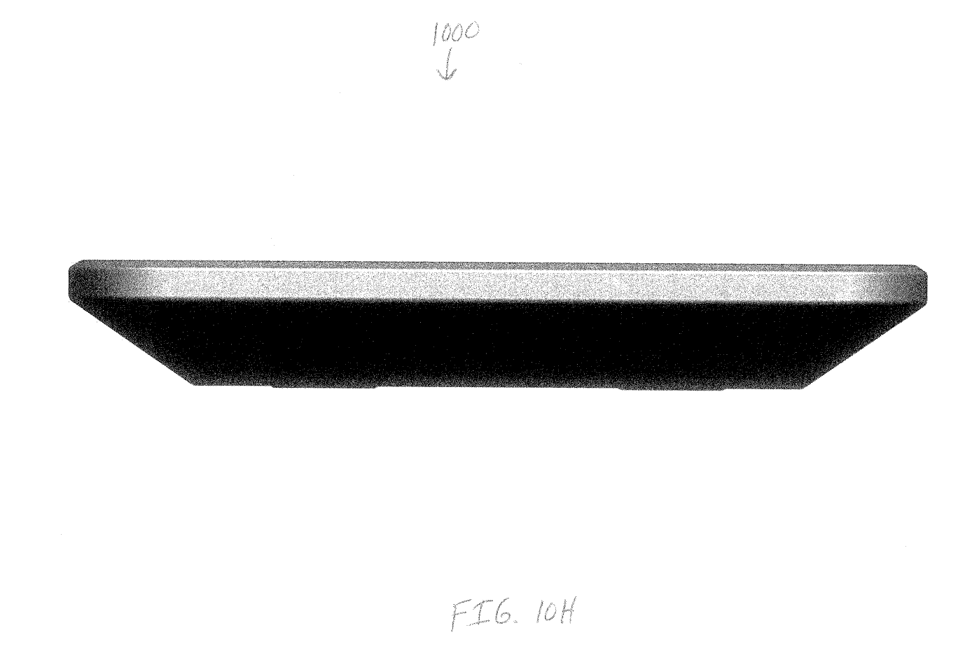

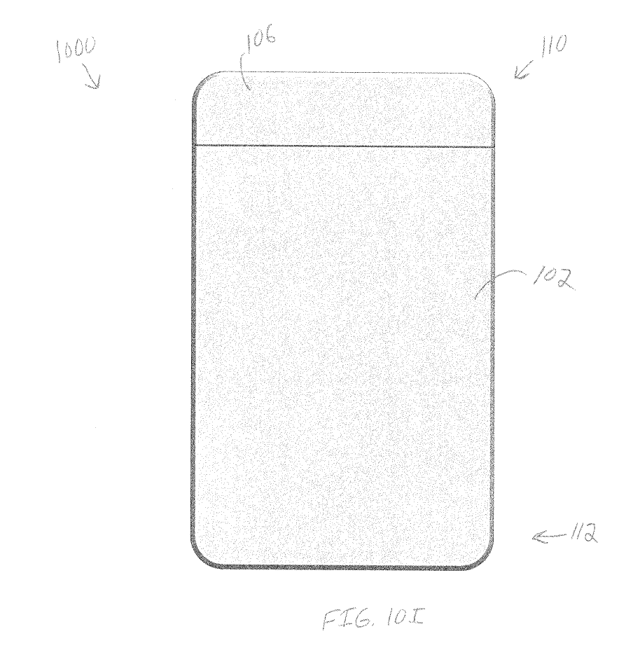

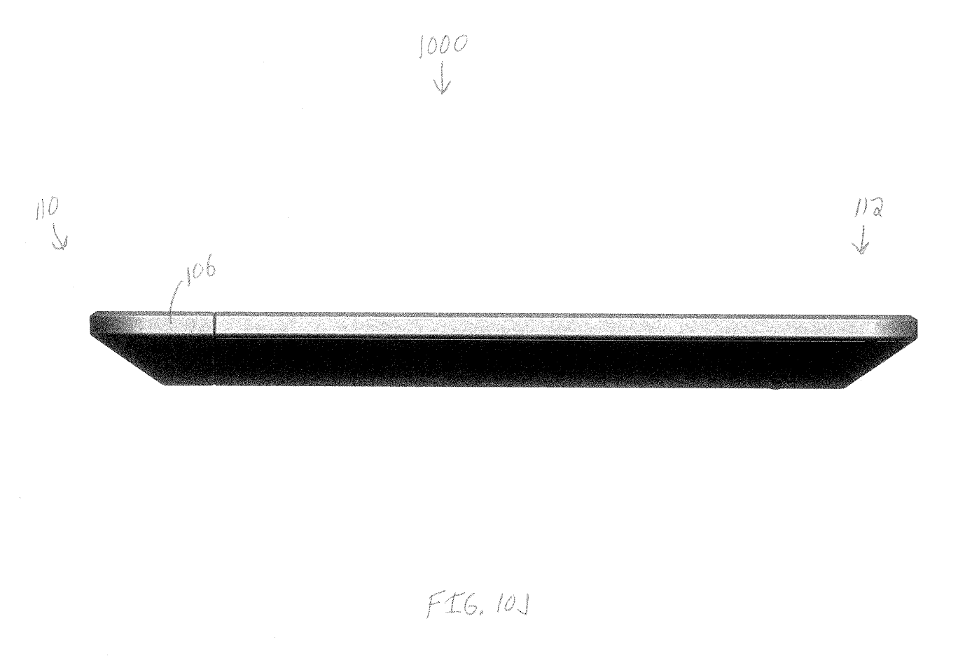

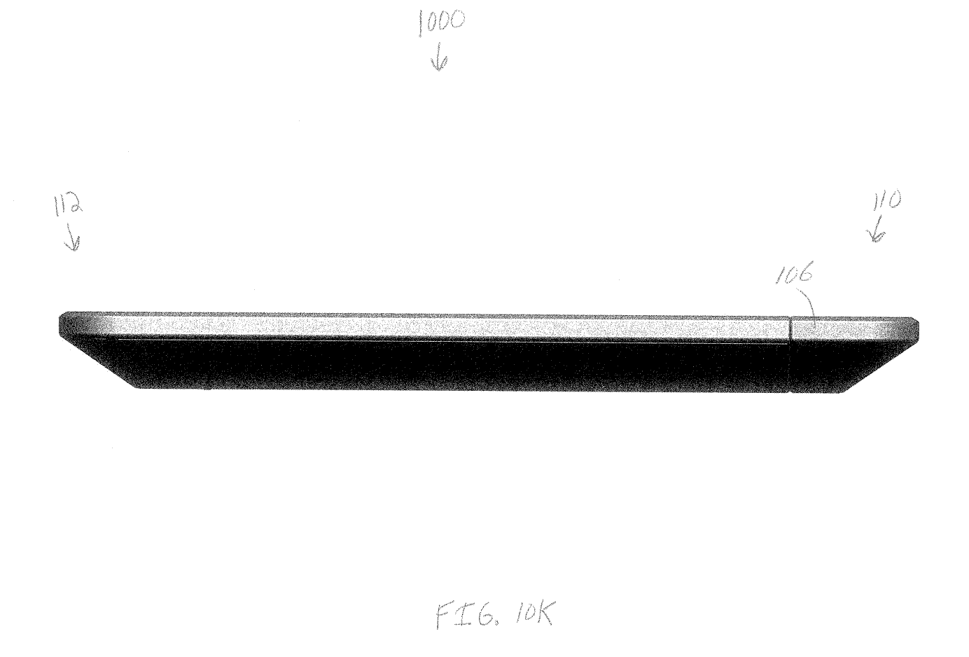

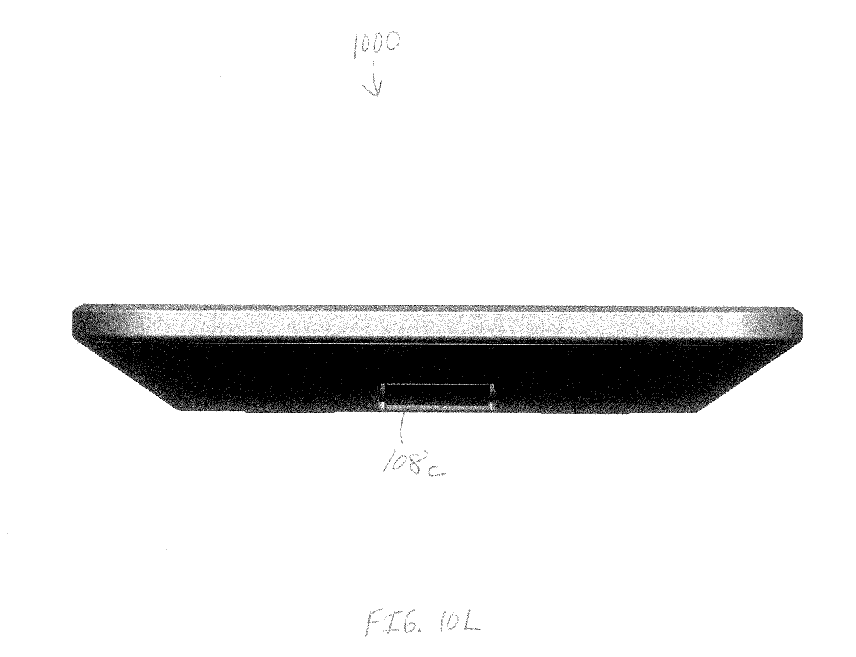

FIGS. 10A-10L illustrate another embodiment of a battery charger 1000. The battery charger 1000 is similar to the battery charger 100 depicted in various other figures and described above. Accordingly, various features of the charger 1000 are referred to in the figures and this description using the same or similar reference numbers as are used with the battery charger 100. For efficiency, each individual feature of the battery charger 1000 may not be fully described below, because such features are the same as or similar to the corresponding features of the battery charger 100 described above.

One difference in the battery charger 1000 as compared to the battery charger 100 is that the battery charger 1000 is configured to work with an electrical outlet that a user may find in, for example, the United Kingdom. The battery charger 100, on the other hand, is designed to work with an electrical outlet that a user may find, for example, in the United States. In addition to adding a third prong 108c, a variety of other differences can be seen in the figures illustrating battery charger 1000, as will be described below.

FIG. 10A illustrates a back perspective view of the charger 1000 with the end cap 106 in place over the jack 130, and with three electrical prongs 108a, 108b, 108c in their open or extended position. FIG. 10B illustrates a side view of the battery charger having the electrical prongs in the open or extended configuration. FIG. 10C illustrates a back perspective view of the charger 1000 having the three electrical prongs 108a, 108b, 108c in their closed or recessed configuration or position. FIG. 10D is a back perspective view similar to the view of FIG. 10A, but with the end cap 106 removed to show jack 130. The jack 130 of the present embodiment is, for example, a Lightning connector for connection with an iPod or iPhone device. However, as described above, various other jacks may be utilized.

FIG. 10D is a back perspective view similar to the view of FIG. 10A, except the prongs 108a, 108b, 108c are in a partially extended position. In this figure, the prongs are shown in a transitional state, such as they would appear if they are transitioning from closed to open or open to closed. FIG. 10F illustrates a back view of the charger 1000 with the electrical prongs in their closed position. FIG. 10G illustrates a front perspective view of the charger 1000. FIG. 10H illustrates a bottom view of the charger 1000. FIG. 10I illustrates a front view of the charger 1000. FIG. 10J illustrates a right side view of the charger 1000. FIG. 10K illustrates a left side view of the charger 1000. FIG. 10L illustrates a top view of the charger 1000.

The first two prongs 108a, 108b of the charger 1000 (e.g., the primary prongs) correspond to the two prongs 108 of charger 100, for example as shown in FIG. 1. These two prongs 108a, 108b are the hot and neutral electrical prongs, meaning the prongs that connect to the hot and neutral lines of an AC electrical outlet. The third electrical prong 108c does not have a corresponding prong on the battery charger 100 shown in FIG. 1. The third prong 108c is a ground prong that is configured to connect to a ground connector of an AC electrical outlet, such as one might find in the United Kingdom. It should be noted, however, that although battery charger 100 shown in FIG. 1 did not include a ground prong, the battery charger 100 may in some embodiments include a ground prong, such as to increase safety and/or stability of the device.

Electrical prongs of the battery charger 1000 do not in this embodiment include sleeves around a base of the prongs, such as the sleeves 118 of battery charger 100 shown in FIG. 1. However, in various other embodiments the electrical prongs 108a, 108b, and/or 108c may include similar features as may be used with battery charger 100 that help to stabilize or retain the battery charger 1000 connected to an electrical outlet (e.g., sleeves 118, or stabilizing, gripping, protrusion, bumper, gasket resilient, and/or deformable members).

One difference between the primary electrical prongs 108a, 108b of charger 1000 and the electrical prongs 108 of battery charger 100 is that the electrical prongs 108a, 108b of battery charger 1000 are configured to rotate in a different direction than the electrical prongs 108 of battery charger 100. With reference to FIG. 1, the electrical prongs 108 are configured to rotate about two parallel axes 132, 134 that are oriented along a longitudinal direction of the housing 101 of the battery charger 100. In the battery charger 1000, on the other hand, the primary prongs 108a, 108b are configured to rotate about the same axis 1132 that is oriented generally transverse to a longitudinal direction of the housing 101 of the battery charger 1000. One benefit to this design is that the electrical prongs 108a and 108b are coupled together through coupling member, central axle, or connecting member 1050 which causes the prongs 108a and 108b to rotate together. For example, if a user were to rotate prong 108a, such as by moving it with his or her finger, prong 108b would move along with prong 108b, even if the user does not touch prong 108b. Such a configuration can be desirable to make the battery charger 1000 easier to use. Such a configuration can also be desirable to increase safety by, for example, reducing the possibility that one prong may be inserted into an electrical outlet while another prong is not in an appropriate position to be inserted into the electric outlet.

With reference to FIGS. 10C and 10D, the electrical prongs 108a and 108b further comprise a protrusion 1052 (e.g., protrusion, lever, handle, switch, and/or the like) configured to enable a user to press against the protrusion 1052 to cause the prongs 108a and 108b to rotate. One reason the protrusion 1052 may be desirable is that in this embodiment the prongs 108a and 108b are recessed respective voids or cavities 114 that do not have an opening along a side of the housing 101 like in the charger 100. Accordingly, it may be more difficult for a user to get his or her finger underneath a distal end of the prongs 108a, 108b to start their rotation outward. This is different than the battery charger 100 as shown in FIG. 1, which comprises open ended recesses 114 that make it easier for a user to get his or her finger underneath an end of the prongs 108 to begin their rotation outward. It should be clear to one of skill in the art that the specific configuration of protrusions 1052 in this embodiment is only one way of providing a method for a user to rotate the prongs outward. Various other methods may be used, including, among other things, positioning one or more protrusions elsewhere, making one or more prongs spring-loaded, including a button or switch or slider mechanism linked to the prongs that causes the prongs to at least partially rotate, and/or the like.

With reference to FIG. 10D, the axle 1050 that connects the prongs 108a and 108b further comprises a recess or cavity 1051 configured to enable the ground prong 108c to be recessed therein in the closed position. This cavity 1051 serves multiple purposes. One purpose is to enable the ground prong 108c to be further recessed within its recess 114. Another purpose or benefit to the recess or cavity 1051 is that, when the primary prongs 108a, 108b are being rotated outward, an edge of the cavity 1051 may press against a surface of the ground prong 108c and cause the ground prong 108v to begin to rotate out itself. Accordingly, with the design shown in FIG. 10E, in some embodiments, a user rotating a single electrical prong, such as electrical prong 108a, may cause all of the other electrical prongs to begin rotating outward. In this embodiment, the ground prong 108c would only be caused to rotate partially outward, and the user would need to manually rotate the ground prong 108c the rest of the way outward; or, for example, a spring or similar mechanism could take over to rotate the ground prong 108c the rest of the way outward. However, in other embodiments, one or more linkages may be included in the battery charger 1000 that connect two or more electrical prongs to each other and cause all three electrical prongs to move to their fully outward position or configuration in response to a single one of the prongs being moved to its fully outward position or configuration.

With reference to FIGS. 10A and 10E, another feature of the ground prong 108c is that it is capable of rotating about two different axes. A first axis 1134 enables the ground prong 108c to rotate from its closed or fully recessed position, such as is shown in FIG. 10C, to its fully open position wherein the ground prong 108c protrudes generally perpendicularly to a back surface of the housing 101, such as is shown in FIG. 10A. In this embodiment, the primary axis 1134 is generally parallel to axis 1132 about which the primary prongs 108a, 108b rotate. In other embodiments, the axes 1134 and 1132 may not be parallel. The ground prong 108c further comprises a secondary axis of rotation 1134′. In this embodiment, the second axis 1134′ is oriented perpendicular to the primary axis 1134. Rotation about the secondary axis 1134′ enables the ground prong 108c to fit within a relatively slim profile of the charger 1000 in its closed position, but to be in a different orientation with respect to axis 1134′ for engaging an electrical outlet. With reference to FIG. 10A, the in-use position of the ground prong 108c is illustrated. It should be apparent from the configuration shown in FIG. 10A that, if the ground prong 108c were to be rotated down into the closed position about axis 1134 without rotating about axis 1134′, or otherwise changing the configuration of the ground prong 108c, the ground prong 108c would not be able to fit within the relatively slim profile of the charger 1000. Some embodiments may, however, allow the ground prong 108c to be recessed within the charger without multiple axes of rotation. Regarding the relatively slim profile of the charger 1000, the discussion above with reference to dimensions A, B, and C of battery charger 100 also applies to battery charger 1000.

It should be apparent to one of skill in the art that the embodiment of a charger 1000 disclosed herein that utilizes two perpendicular axes of rotation 1134, 1134′ to enable the ground prong 108c to be positioned relatively flat within a recess 114 of the charger 1000, but to be oriented differently in use with a UK outlet, is only one way of implementing such a feature. Various other methods may be used, such as, for example, a ground prong 108c that is expandable in at least one direction, a spherical or arc-path rotation joint that simultaneously pivots the ground prong 108c away from the housing and into a proper position without requiring two discreet rotation axes, and/or the like. Further, in some embodiments, the ground prong may be configured to rotate about a single axis oriented generally along a longitudinal direction of the charger 1000, similarly to how the prongs 108 of battery charger 100 rotate.

In some embodiments of battery chargers disclosed herein, detent or similar features may be incorporated that enable electrical prongs, such as prongs 108, 108a, 108b, 108c, to be retained or held in the fully open or fully closed position. Such features may be desirable to, among other things, stop or resist the prongs from moving from the open or closed position through vibration, shaking, the act of inserting the prongs into an outlet, and/or the like. Further, various embodiments may comprise a spring-loaded design or other features that assist a user in moving prongs between the open and/or closed positions.

Certain implementations of the battery charger 100 include one or more of the following: improved quality, safety, portability, feel, functionality, and/or a more luxurious, seamless, clean, stream-lined and aesthetically-pleasing appearance, as the battery charger 100 can be compact, thin, properly insulated electrically, able to be securely engaged with an electrical socket or outlet and/or made of metal.

Although the battery charging systems have been disclosed in the context of certain embodiments and examples (e.g., the battery charger 100), it will be understood by those skilled in the art that the battery charging systems extend beyond the specifically disclosed embodiments to other alternative embodiments and/or uses of the embodiments and certain modifications and equivalents thereof. Various features and aspects of the disclosed embodiments can be combined with or substituted for one another in order to form varying modes of the charging system. The scope of this disclosure should not be limited by the particular disclosed embodiments described herein.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Terms of orientation used herein, such as “top,” “bottom,” “upper,” “lower,” “front,” “back,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally perpendicular” can refer to something that departs from exactly parallel by less than or equal to 20 degrees.

Some embodiments have been described in connection with the accompanying drawings. The figures are drawn to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

In summary, various embodiments and examples of battery charging systems have been disclosed. Although the battery charging systems have been disclosed in the context of those embodiments and examples, it will be understood by those skilled in the art that this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow.

The following is claimed:

1. A battery charging system for a communication device, the battery charging system comprising:
a housing;
a charging circuit positioned within the housing, the charging circuit comprising electrical components configured to convert an electrical input into a regulated output suitable for use in charging the communication device;
an electrical prong pivotally coupled to the housing, the electrical prong having a closed position and an open position, wherein, in the closed position, the electrical prong is positioned substantially within a cavity of the housing, and, in the open position, the electrical prong extends from a back surface of the housing in a configuration enabling the electrical prong to be inserted into an electrical outlet to close an electrical connection between the charging circuit and the electrical outlet,
wherein the electrical prong comprises a protrusion positioned at a base of the prong, the protrusion sized to produce an interference fit with the electrical outlet; and
an electrical connector at least partially protruding from a bottom surface of the housing, the electrical connector configured to engage a mating electrical jack of the communication device to enable the regulated output to charge the communication device.

2. The battery charging system of claim 1, wherein the protrusion comprises a sleeve extending around the base of the prong.

3. The battery charging system of claim 1, wherein the protrusion comprises a resilient material.

4. The battery charging system of claim 1, wherein the protrusion comprises silicone.

5. The battery charging system of claim 1, wherein the electrical prong is configured to pivot about a first axis, the first axis being substantially parallel to a longitudinal axis of the housing.

6. The battery charging system of claim 5, wherein the electrical prong is further configured to pivot about a second axis, the second axis being substantially perpendicular to the first axis.

7. The battery charging system of claim 5, further comprising:
a second electrical prong pivotally coupled to the housing, wherein the second electrical prong is configured to pivot about a second axis, the second axis being parallel to the first axis,
wherein the second electrical prong comprises a second protrusion positioned at a base of the second prong, the second protrusion sized to produce an interference fit with the electrical outlet.

8. The battery charging system of claim 5, wherein the electrical prong is mechanically coupled to a second electrical prong such that both electrical prongs pivot together about the first axis.

9. The battery charging system of claim 1, wherein the housing comprises an electrically conductive material and the battery charging system further comprises:
an insulating layer comprising a material having electrical insulating properties, the insulating layer positioned at least partially between the housing and the charging circuit.

10. The battery charging system of claim 1, further comprising:
an end cap comprising a cavity sized to cover the electrical connector when the electrical connector is not connected to the communication device.

11. The battery charging system of claim 10, wherein the end cap is hingedly connected to the housing.

12. The battery charging system of claim 10, wherein the end cap is removably connected to the housing, and the end cap and housing each comprise a magnetic portion configured to enable the end cap to be stored magnetically affixed to the housing when the end cap is not covering the electrical connector.

13. The battery charging system of claim 12, wherein the magnetic portion of the end cap comprises at least one magnet, and the magnetic portion of the housing comprises a ferrous material.

14. The battery charging system of claim 1, wherein the electrical connector comprises a movable protrusion configured to be positioned within a cavity of the electrical jack to at least partially support a weight of the communication device.

15. The battery charging system of claim 1, wherein the housing comprises a maximum thickness of about 8 millimeters.

16. A battery charging system for a communication device, the battery charging system comprising:
a housing comprising an electrically conductive material;
a charging circuit positioned within the housing, the charging circuit comprising electrical components configured to convert an electrical input into a regulated output suitable for use in charging the communication device;
an electrical prong sized to be inserted into an electrical outlet to close an electrical connection between the charging circuit and the electrical outlet;
an electrical connector at least partially protruding from a bottom surface of the housing, the electrical connector configured to engage a mating electrical jack of the communication device to enable the regulated output to charge the communication device; and
a first insulating layer comprising a material having electrical insulating properties, the insulating layer positioned at least partially between the housing and the charging circuit.

17. The battery charging system of claim 16, wherein the housing comprises aluminum.

18. The battery charging system of claim 16, wherein the first insulating layer comprises plastic.

19. The battery charging system of claim 16, further comprising:
a second insulating layer comprising a material having electrical insulating properties,
wherein the first insulating layer is positioned at least partially between a front portion of the housing and the charging circuit, and
wherein the second insulating layer is positioned at least partially between a back portion of the housing and the charging circuit.

20. The battery charging system of claim 16, wherein the electrical prong is pivotally coupled to the housing, the electrical prong having a closed position and an open position, wherein, in the closed position, the electrical prong is positioned substantially within a cavity of the housing, and, in the open position, the electrical prong extends from the back surface of the housing in a configuration enabling the electrical prong to be inserted into the electrical outlet.

21. The battery charging system of claim 20, wherein the electrical prong comprises a protrusion positioned at a base of the prong, the protrusion sized to produce an interference fit with the electrical outlet.

22. The battery charging system of claim 20, wherein the electrical prong is pivotally coupled to the housing such that the electrical prong can rotate about a first axis, and the electrical prong is further configured to pivot about a second axis oriented perpendicular to the first axis.

23. The battery charging system of claim 20, wherein the electrical prong is mechanically coupled to a second electrical prong such that pivoting of one of the prongs causes the other prong to also pivot.

24. A battery charging system for a communication device, the battery charging system comprising:
a housing;
a charging circuit positioned within the housing, the charging circuit comprising electrical components configured to convert an electrical input into a regulated output suitable for use in charging the communication device;
an electrical prong pivotally coupled to the housing, the electrical prong having a closed position and an open position, wherein, in the closed position, the electrical prong is positioned substantially within a cavity of the housing, and, in the open position, the electrical prong extends from the back surface of the housing in a configuration enabling the electrical prong to be inserted into an electrical outlet to close an electrical connection between the charging circuit and the electrical outlet;
an electrical connector at least partially protruding from a bottom surface of the housing, the electrical connector configured to engage a mating electrical jack of the communication device to enable the regulated output to charge the communication device; and
a locking member configured to engage the communication device to at least partially support a weight of the communication device while the electrical connector is engaged with the electrical jack of the communication device.

25. The battery charging system of claim 24, wherein the electrical connector comprises the locking member.

26. The battery charging system of claim 24, wherein the housing comprises the locking member.

27. The battery charging system of claim 24, wherein the locking member is configured to engage a cavity of the communication device to at least partially support the weight of the communication device.

28. The battery charging system of claim 24, wherein the locking member is configured to at least partially support the weight of the communication device using friction.

29. The battery charging system of claim 24, wherein the electrical prong is mechanically coupled to a second electrical prong such that pivoting of one of the prongs causes the other prong to also pivot.

30. The battery charging system of claim 24, wherein the electrical prong is pivotally coupled to the housing such that the electrical prong can rotate about a first axis, and the electrical prong is further configured to pivot about a second axis oriented perpendicular to the first axis.
